(19) United States
(12) Patent Application Publication
(10) Pub. No.: US 2025/0278653 A1
(43) Pub. Date: Sep. 4, 2025

(54) PARAMETRIZING A QUANTUM GATE INTO A DATA-ENCODING VARIATIONAL GATE

(71) Applicant: State Farm Mutual Automobile Insurance Company, Bloomington, IL (US)

(72) Inventors: Zhoushen Huang, Westmont, IL (US); Michael H. Skelton, Austin, TX (US); Adrian Bolt, Richardson, TX (US)

(21) Appl. No.: 18/806,454

(22) Filed: Aug. 15, 2024

Related U.S. Application Data
(60) Provisional application No. 63/651,096, filed on May 23, 2024.
(60) Provisional application No. 63/559,698, filed on Feb. 29, 2024.
(60) Provisional application No. 63/520,457, filed on Aug. 18, 2023.

(51) Int. Cl. G06N 10/20; G06N 10/60

(52) U.S. Cl. CPC G06N 10/20; G06N 10/60

(57) ABSTRACT

A method, program code, and computing device including at least one memory, and at least one processor in communication with the at least one memory, wherein the at least one processor is programmed to generate a quantum feature map corresponding to a quantum circuit, wherein the quantum feature map includes a plurality of gates; employ variational data-encoding parameterization to the quantum feature map to convert at least one gate of the plurality of gates into a variational data-encoded gate; and execute machine learning processes using the quantum feature map to determine a value for a variational data-encoded parameter associated with the at least one variational data-encoded gate.

### CROSS REFERENCE TO RELATED APPLICATIONS

This application claims the benefit of and priority to U.S. Provisional Application No. 63/651,096, filed May 23, 2024, and also claims the benefit of and priority to U.S. Provisional Application No. 63/559,698, filed Feb. 29, 2024, and further claims the benefit of and priority to U.S. Provisional Application No. 63/520,457, filed Aug. 18, 2023, which are all hereby incorporated herein by reference in their entireties.

### FIELD OF THE DISCLOSURE

The present disclosure generally relates to quantum computation, and, more particularly, to systems and methods for parametrizing a quantum gate into a data-encoding variational gate.

### BACKGROUND

Quantum machine learning algorithms may involve translating classical data to their quantum mechanical representation. Such representations, due to their potential in leveraging unique quantum characteristics such as entanglement, may offer new insights into data that may otherwise be hard to come by using classical data embedding techniques.

The quality of the quantum representation may place a ceiling on the predictive power of the overall learning algorithm. Once this translation is accomplished, the task to learn from the quantum representation may either be handed over to (i) a classical algorithm, an example being the quantum support vector machine, or to (ii) other quantum processes, such as variational quantum circuits, if further quantum advantages can be expected to be leveraged, for example, in finding a classifying hyperplane.

Accordingly, there exists a need for improved systems and methods for evaluating quantum mechanical representation. Conventional techniques may include additional encumbrances, inefficiencies, ineffectiveness, and/or other drawbacks, as well.

### BRIEF SUMMARY

The present embodiments may relate to, inter alia, computer-implemented methods and computer systems for developing a metric for evaluating a classical-to-quantum mechanical representation (e.g., a quantum feature map) based upon the quantum feature map, itself. In particular, the system and method described herein may include (i) generating a quantum feature map that corresponds to a quantum circuit; (ii) employing variational data-encoding parameterization to the quantum feature map; (iii) providing a layer of data-encoding qubit gates to the quantum feature map; and/or (iv) performing machine learning processes using the quantum circuit.

The system and method described herein may involve creating a systematic parametrization scheme of arbitrary quantum gates, to make them data-encoding and variational gates. And by applying the appropriate limits of the scheme, the system may reduce the resulting parametrized gates to being either data-encoding or variational. The results of the numerical experiments using this new scheme show that using the same circuit structure, the parametrization scheme proposed herein is able to efficiently train a quantum neural network for a task that is impossible if parametrized using existing techniques (known in the literature as “variational quantum neural network”). The difference in computational cost of the two schemes may be virtually non-existent.

In one aspect, a computer system for translating a representation of classical data to quantum space as input to a quantum circuit may be provided. The computer system may include one or more local or remote processors, servers, computing devices or classical computing devices, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. For instance, a computing device may include at least one memory and at least one processor in communication with the at least one memory. The at least one processor may be programmed to (i) generate a quantum feature map corresponding to a quantum circuit, wherein the quantum feature map includes a plurality of gates; (ii) employ variational data-encoding parameterization to the quantum feature map to convert at least one gate of the plurality of gates into a variational data-encoded gate; and/or (iii) execute machine learning processes using the quantum feature map to determine a value for a variational data-encoded parameter associated with the at least one variational data-encoded gate. The computer system may include additional, less, or alternate functionality, including that discussed elsewhere herein.

In another aspect, a computer-implemented method may be provided. The computer-implemented method may be implemented using one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. The computer-implemented method may include (i) generating a quantum feature map corresponding to a quantum circuit, wherein the quantum feature map includes a plurality of gates; (ii) employing variational data-encoding parameterization to the quantum feature map to convert at least one gate of the plurality of gates into a variational data-encoded gate; and/or (iii) executing machine learning processes using the quantum feature map to determine a value for a variational data-encoded parameter associated with the at least one variational data-encoded gate. The computer system may include additional, less, or alternate functionality, including that discussed elsewhere herein.

In another aspect, a non-transitory computer-readable storage medium with instructions stored thereon may be provided. The computer-executable instructions may be executed using one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. When executed by the at least one processor, the computer-executable instructions may cause the at least one processor to (i) generate a quantum feature map corresponding to a quantum circuit, wherein the quantum feature map includes a plurality of gates; (ii) employ variational data-encoding parameterization to the quantum feature map to convert at least one gate of the plurality of gates into a variational data-encoded gate; and/or (iii) execute machine learning processes using the quantum feature map to determine a value for a variational data-encoded parameter associated with the at least one variational data-encoded gate. The computer-executable instructions may include additional, less, or alternate functionality, including that discussed elsewhere herein.

Embodiments of the system may promote conventional variational gates, which do not encode data, to variational data-encoding gates. This promotion may significantly improve quantum machine learning performance at no additional computational cost. Other advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

Example embodiments are shown in the drawing arrangements which are presently discussed herein. It should be understood, however, that the present embodiments are not limited to the precise arrangements and instrumentalities shown herein.

FIG. 1 illustrates an exemplary embodiment of a variational data-encoding circuit system for linearly connected qubits.

FIG. 2 depicts a process flow diagram for an exemplary computer-implemented method performed by a quantum computing device shown in FIG. 3.

FIG. 3 depicts an exemplary diagram of an ensemble of quantum computing devices for executing a quantum application on a quantum computing device of the type that may generate the system of FIG. 1.

FIG. 4 depicts an exemplary configuration of an application server (or a classical computing device), in accordance with one embodiment of the present disclosure.

FIG. 5 is a flow diagram illustrating an exemplary embodiment of a method of promoting variational gates, which do not encode data, to variational data-encoding gates, as may be executed by the processing devices of either FIG. 3 or 4.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, network-based systems and methods for evaluating a quantum feature map including translating a representation of classical data to quantum space as input to a quantum circuit. More specifically, a system configured to set-up a circuit with multiple gates, wherein at least one gate simultaneously includes at least one variational parameter and data encoding. Recent developments in quantum computing have pushed quantum computers closer to solving classically intractable problems. Existing quantum programming languages and compilers use a quantum assembly language composed of 1- and 2-quantum bit (“qubit”) gates to prepare and execute primitive operations on quantum computers. Recent advancements in hardware and software include devices such as IBM's 50-qubit quantum machine and Google's 72-qubit machine, as well as classical-quantum hybrid algorithms tailored for such Noisy Intermediate-Scale Quantum (“NISQ”) machines, such as Quantum Approximate Optimization Algorithm (“QAOA”) and Variational Quantum Eigensolver (“VQE”).

As discussed herein, a quantum circuit may consist of elementary quantum gates, and each gate is specified by a “rotation axis” (technically a Hermitian operator) and a “rotation angle” (technically a real-valued number). A gate changes the quantum state of the underlying hardware to which it is applied. If the rotation angle is chosen from some piece of classical data (or a function thereof), then the resulting quantum state would also depend on, and thereby, encode that data.

The training of quantum machine learning algorithms, from this perspective, may be viewed as finding the best-possible circuit structure and circuit parameters tuned to the data in hand. Practical constraints such as resources, time, hardware capability, however, demand that any such search be performed within a much smaller subspace of circuits than theoretically allowed (the latter being the space of unitary operators). Selecting, defining, and navigating this subspace is of paramount importance to the practical application of quantum machine learning.

The search of an optimal solution in a confined subspace is usually formulated as a variational problem, where the explored solutions may have particular functional forms, and the degrees of freedom of the search are represented as (variational) parameters of the functions. In the context of quantum computing, the functional forms are stipulated by the structure of the quantum circuits (e.g., what gates to use, how they are interconnected, etc.), and their parametrization as the rotation angles of the constituent gates. Quantum variational circuits were first developed for solving eigenvalue or other related optimization problems, and naturally do not involve data (because there is none to train on). This absence of data in variational circuit elements, or more appropriately, the decoupling between data and variational parameters, has carried over to quantum machine learning as well.

Conventional systems employ variational techniques in quantum machine learning to treat individual gates in the entire circuit as either data-encoding only (and therefore not equipped with variational parameters), or variational only (in which case there is no data dependence), but never both (that is, a data-encoding variational gate). Such a dichotomy is rather ad hoc, and often obscures the nature of the underlying variational space. Different conventional parametrization schemes (that is, different choices of variational vs data-encoding gates) of the same circuit structure may yield different spaces of variational circuits.

The systems and methods described herein are directed to creating a systematic parametrization scheme of arbitrary quantum gates, to make them data-encoding and variational gates. By taking appropriate limits, the systems and methods described herein reduces the resulting parametrized gates to being either data-encoding or variational, thereby recovering, and unifying, the aforementioned dichotomy in existing works.

For the purposes of this discussion, the feature map may be considered the functionality from the perspective of the machinery, i.e., the hardware. Furthermore, the whole circuit may be considered a feature map with gates that can encode data and allow the flexibility of the variational parametrization. Moreover, having gates that perform both data encoding and variational in the same gate, allows the system to bridge together several different types of algorithms that were not able to be performed with just variational or data encoded gates.

When the classically intractable problems are targeted for solving using quantum computing, classical data may be translated to its quantum mechanical representation. Such representations offer new insights into the data that may be hard to come by in classical data embedding techniques. The insights may be due to their potential in leveraging unique quantum characteristics such as entanglement. A particular way in which the classical data is represented for input to a quantum circuit places a constraint on the predictive power of the overall learning algorithm. Accordingly, the particular translation of the classical data into a quantum space may be an input to a quantum circuit or map.

In an exemplary embodiment of the system, an arbitrary quantum gate U is specified by a Hermitian generator (the “rotation axis”) H, and a real number f (the “rotational angle”): U(H, f)=exp(i f H). With reference to the foregoing equation, existing works use f to either represent a piece of classical data, or as a tunable (variational) parameter. In the scheme described herein, f may be a function of data, and the decomposition coefficients of this function may be used in some user-selected function bases as the variational parameters. In polynomial terms, an example of the expansion may be a Taylor expansion as shown in EQ. 1:

$$f ( x , θ ) = {θ}^{( 0 (} + {\sum }_{i} {θ}_{i}^{( 1 )} {x}_{i} + \frac{1}{2} {\sum }_{ij} {θ}_{ij}^{( 2 )} {x}_{i} {x}_{j} + \frac{1}{6} {\sum }_{ijk} {θ}_{ijk}^{( 3 )} {x}_{i} {x}_{j} {x}_{k} + … , \qquad EQ . 1$$

In the above equation (EQ. 1), i is the feature index (so xᵢ is the ith feature of data point x). In the above equation (EQ. 1), f is linear in θ. In the example, if trigonometric functions were used as an expansion bases, the equation would become a Fourier transform of x, with θ comprising the corresponding Fourier coefficients.

The complexity of the variational gate U(H, f(x, θ)) may be controlled by imposing additional rules to the variational parameters θ. For example, if θ⁽⁰⁾ is only allowed to be non-zero, and all other θ^{(a≥1)}'s are set to be zero, then the gate U becomes data independent and reduces to a conventional variational gate. Alternatively, if θ₂⁽¹⁾=1 and all other variational θ's are set to zero, then the gate only encodes a single feature x₂ of the data. As such, the parametrization scheme encompasses both the variational gates and the data-encoding gates. As a consequence, there is a variational path connecting between the two limits. The path ensures that the outcome of variational optimizations based on the parametrization will outperform the better of the two, or be at least as good as the other. The goal is to determine the optimal value of the variational parameter θ. More specifically, the machine learning and training of the circuit, determines the value of variational parameter θ that will give the model the best results. The variational models are using parameters to analyze a plurality of solutions. In the exemplary embodiment, θ may range between 0 and 2π.

Depending on the nature of the generator H, domain insights can be employed to filter the set of variational parameters to include by setting others to be identically zero. For example, if H is a two-qubit operator, and each qubit encodes one classical feature, then the parametrization may be truncated in EQ. 1 at the second order by setting θ^{(a≥3)}=0. This setting may allow two classical features to interact, but not three classical features.

### Variational Data-Encoding Circuit System for Linearly Connected Qubits

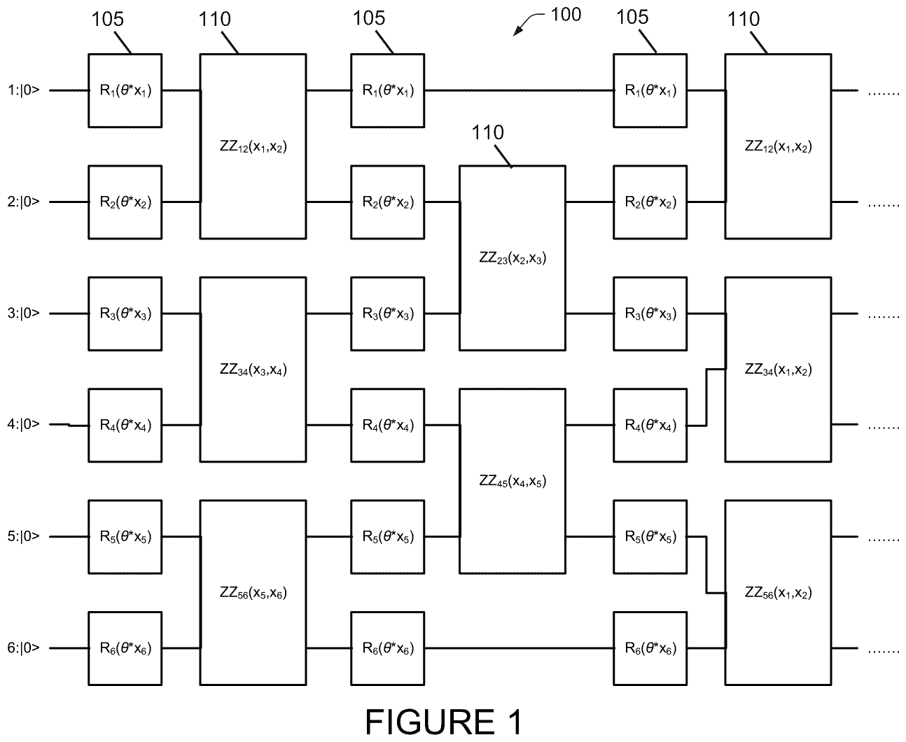

FIG. 1 illustrates an exemplary embodiment of a variational data-encoding circuit system 100 for linearly connected qubits. In particular, FIG. 1 includes θ*xᵢ in the R_{y} implementation.

An exemplary embodiment may promote conventional variational gates, which do not encode data, to variational data-encoding gates. This promotion may significantly improve quantum machine learning performance at no additional computational cost. More particularly, implementation of circuit system 100 may improve model predictive power using variational data-encoding gates. Parametrization may be accomplished using an open-source Iris dataset on a binary classification problem. With six classical features (e.g., x₁ to x₆) and a single variational parameter θ. The system 100 employs variational data-encoding parametrization on the first layer of single-qubit R_{y} rotations 105, followed by a layer of conventional data-encoding two-qubit ZZ gates (e.g., non-variational) 110. This is repeated in another layer of Ry rotations 105 and a layer of shifted data-encoding two-qubit ZZ gates 110. In the exemplary embodiment, the system 100 repeats these layers to create the needed circuit as described further herein. Furthermore, the output of the circuit is used to train the model(s).

The results may be compared to conventional parametrization, where the R_{y} layer is purely variational, and the ZZ layer is purely data-encoding. The primary difference may be using θ*xᵢ in the R_{y} implementation, as opposed to the standalone θ in a less effective one. In other embodiments, either or both of the Ry layer and the ZZ layer may be variational data-encoded. These configurations may incur the same computational cost. Yet the modification improves the classification performance in numerical testing from about 85% to 100% accuracy. More particularly, implementation of circuit system 100 may improve model predictive power using variational data-encoding gates.

The system 100 includes a variational data-encoding circuit using 6 or 7 qubits, which are representative of even and odd counts of qubits. The circuit assumes physical connectivity of the qubits are linear. In 7 qubits embodiments, the elements may only be used if the 7^{th} qubit is present. For system 100, EQ. 2 and EQ. 3 are as follows:

$$= exp [ i {\sum }_{p ∈ \{ X , Y , Z \}} f ( {x}_{i} , ) {σ}_{p}^{( i )} ] , \qquad EQ . 2$$

$$= exp [ if ( {x}_{i} , {x}_{j} , ) {σ}_{Z}^{( i )} {σ}_{Z}^{( j )} ] , \qquad EQ . 3$$

where f(⋅) is the parametrization function such as in EQ. 1 and if a polynomial function basis is being used, then θ and ϕ are the variational parameters, l is the circuit layer index, and i, j are the qubit indices.

As shown in FIG. 1, the rules of circuit composition for a generic count of qubits and a generic circuit depth may include: (1) The sequence of operations on any specific qubit is an alternation between single- and two-qubit gates. The sequence should start and end with a single-qubit gate, although either and/or both may be the identity gate. (2) The single-qubit gates are generic U(2) unitaries. (3) The two-qubit gates are all ZZ gates. Theoretically, this is because any other directions can be factored out of the two-qubit gates into the single-qubit gates around them. (4) Two consecutive two-qubit gates (e.g., along the horizontal direction) acting on the same qubit cannot connect the latter to the same neighbor. (5) A priori, the variational parameters of different gates are mutually independent. The variational parameters may be constrained to be partially identical to control the size of the variational parameter space. (6) The circuit may grow in both directions via straightforward pattern replication.

While FIG. 1 illustrates the R_{y} rotations 105 including both data encoding and variational parameters, one having skill in the art would understand that any combination of the gates may include both. Furthermore, the system 100 may include any number of variational gates, data encoded gates, and gates that include both. This combination and structure may be set by the user, the algorithms to be used and/or any other item as needed. Furthermore, the layers of R_{y} rotations 105 and ZZ gates 110 may be interchanged and/or otherwise reconfigured as needed. The current configuration shown in FIG. 1 is for example purposes only.

For a given value of θ, a support vector machine algorithm may then be used to perform a prediction based on data, and the quality of the predictions (typically formulated as a cost function), as a function of the value θ, can then be used to guide the optimization of the choice of θ (i.e., variational training). The SVM is used to compute predictions based on θ. θ is trained variationally to improve the quality of the predictions. In the exemplary embodiment, the cost function is a downstream comparison to the truth to make sure that the model making the prediction may be the ideal model.

While the above uses θ*xᵢ, one having skill in the art would understand that other combinations may be used as well, including, but not limited to, θ²*xᵢ, θ*xᵢ+θ²*xᵢ, and others.

### Process Flow Performed by Quantum Computing Device

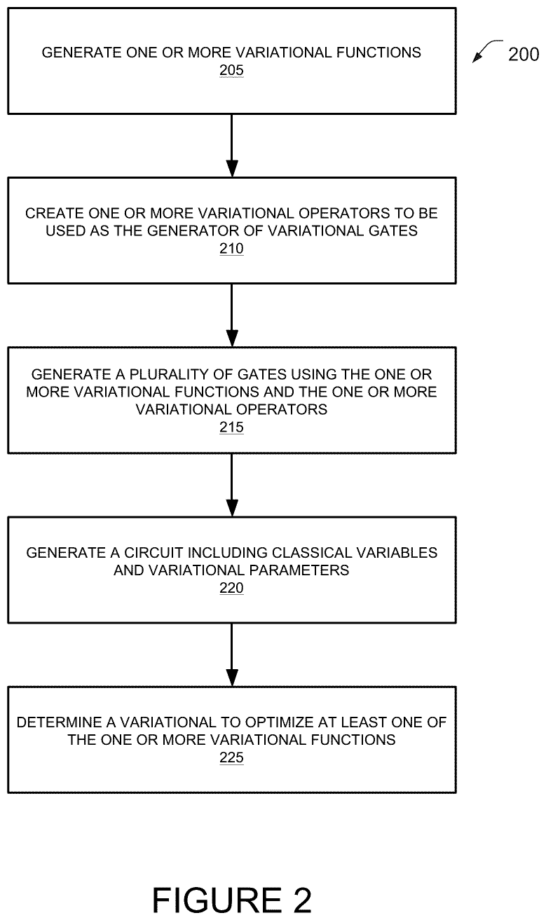

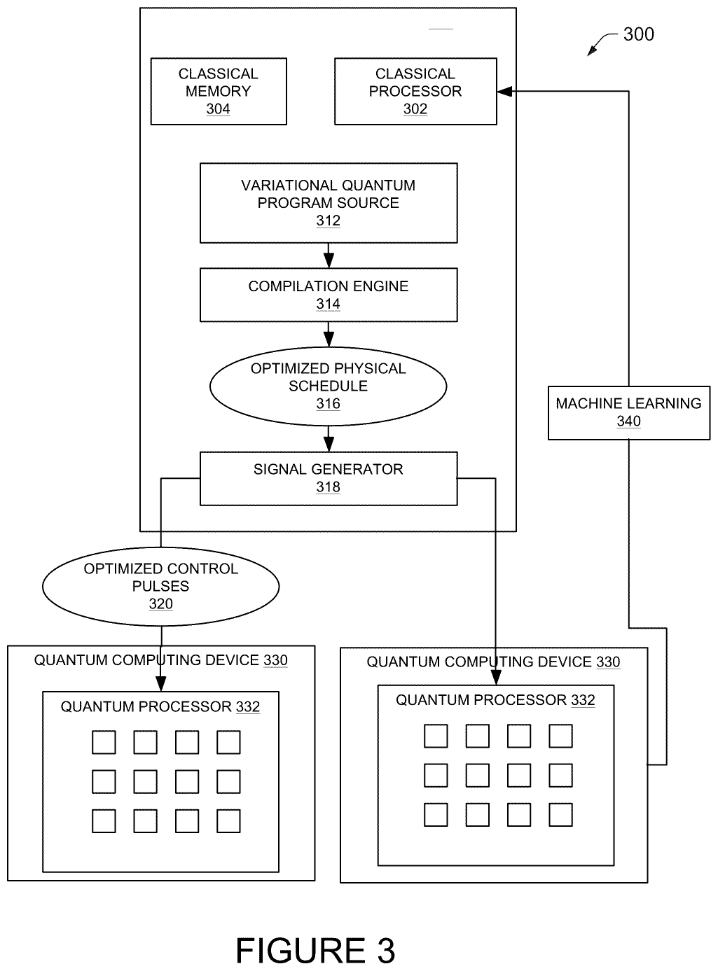

FIG. 2 depicts a process flow diagram for an exemplary computer-implemented method 200 performed by a quantum computing device 330 (shown in FIG. 3).

In Block 205, one or more variational functions are generated. These may be generated by a user and/or by the desired end functions. A variational function is a linear sum of basis functions, with the linear coefficients acting as variational parameters. “Variational parameters” are not to be confused with “variables,” which are dependable of the basis functions. In quantum machine learning, “variables” corresponds to classical data, whereas “variational parameters” are parameters of QML models to be (variationally) optimized.

In Block 210, one or more variational operators to be used as the generator of variational gates are created.

In Block 215, a plurality of gates using the one or more variational functions and the one or more variational operators are generated. In the exemplary embodiment, the gates are created by associating generators to qubits. This may include optionally supplying a label to each gate. Note that the variational generators may be reused multiple times. In these embodiments, the gates take both variational parameters and variables as inputs.

In Block 220, a circuit including classical variables and variational parameters is generated. In a variational algorithm, the user has a group of variables (e.g., classical data), and another group of variational parameters (e.g., modal parameters). These variables and parameters can be reused in multiple places in the variational circuit (or selectively ignored) to create e.g. the effect of ‘constraints’. Invoking with these user data then instantiates a concrete circuit where each gate in the circuit is given a specific number (computed from the variational functions in each gate). This concrete circuit is what is seen by the hardware.

In Block 225, a variational parameter to optimize at least one of the one or more variational functions is determined. In some embodiments, there is a single variational parameter. In other embodiments, there are multiple variational parameters to be solved for. From a mathematical point of view, the system 100 is trying to optimize or minimize the variational function (the function of θ). In some embodiments, the function being minimized is a cost function, which captures how well the model is performing. In these embodiments, the cost function is a downstream comparison to the truth to make sure that the model making the prediction may be the ideal model.

In some embodiments, the gates are grouped into layers for logical convenience. In other embodiments, the gates are grouped in other methodologies. In still further embodiments, the gates are not grouped at all.

In some embodiments, a variational circuit of the canonical structure can be constructed conveniently by specifying three variational functions for 1-qubit gates, and one variational function for 2-qubit gates. For example, the settings may include, but are not limited to, the number of classical variables, the number of qubits, the number of variation parameters per gate, the number of variables per gate, variable passed to all single qubit gates, variable passed to the first qubit gate, variable passed to the second qubit gate, a number of classical variables to encode with each 1-quibit gate, the max number of polynomial order of 1-quibit gates, the number of classical variables to encode with each 2-qubit gate, the number of repetitions, whether or not to use periodic boundary conditions, and/or others as desired.

In a variational feature map, the angles going into a quantum gate should, each, be a variational function. A variational function is a linear combination of basis functions, with the linear coefficients as variational parameters. In some embodiments, the system 100 further includes a mechanism to designate a variational parameter as non-variational; a “connectivity” matrix to map a vector of (variational) parameters to the set of basis functions (so potentially multiple basis functions can use the same variational parameter as a constraint); the “connectivity matrix” can at the same time be used to indicate if a parameter is variational (as +1) or non-variational (as −1).

### Exemplary Quantum Computing System

FIG. 3 depicts a diagram of an exemplary ensemble of quantum system 300 for executing a quantum application on a quantum computing device 330. The ensemble of quantum system 300 may include a control computing device 310 that is configured to prepare (e.g., compile and optimize) a quantum application 312 (e.g., a quantum feature map) for execution on the quantum computing devices 330. In particular, different quantum application operations of the quantum application may be executed in parallel using the quantum computing devices 330. More than one quantum computing device of the plurality of quantum computing devices 330 may perform a particular or a respective quantum application operation of the quantum application operations of the quantum application 312 in parallel.

The control computing device 310 may include a classical processor 302 (e.g., a central processing unit (“CPU”), an x86-based processor, or the like) that may be configured to execute classical processor instructions, a classical memory 304 (e.g., random access memory (“RAM”), memory SIMM, DIMM, or the like, which includes classical bits of memory). A quantum computing device 330 of the quantum computing devices 330 may include multiple qubits 334 that represent a quantum processor 332 upon which the quantum application 312 is executed.

In some examples, the quantum application 312 may be a variational quantum application program that interleaves compilation with computation during runtime, and the quantum processor 332 may include 50 or 100 qubits. However, it should be understood that the present disclosure is envisioned to be operable and beneficial for quantum processors with any number of qubits, for example, many tens, hundreds, or more qubits 334.

The fundamental unit of quantum computation is a quantum bit (or a qubit) 334. In contrast to classical bits (“cbits”), qubits are capable of existing in a superposition of logical states, notated herein as |0 [symbol] and |1 [symbol] . The general quantum state of a qubit may be represented as:

$$\vert ψ1 〉 = α \vert 0 〉 + β \vert 1 〉 ,$$

where α, β are complex coefficients with |α|²+|β|²=1. When measured in the 0/1 basis, the quantum state collapses to |0 [symbol] or |1 [symbol] with a probability of |α|² and |β|², respectively. The qubit 334 may be visualized as a point on a 3D sphere called the Bloch sphere. Qubits 334 may be realized on different Quantum Information Processing (QIP) platforms, including ion traps, quantum dot systems, and, in the example embodiment, superconducting circuits. The number of quantum logical states grows exponentially with the number of qubits 334 in the quantum processor 332. For example, a system with three qubits 334 can live in the superposition of eight logical states: |000 [symbol] , |001 [symbol] , |010 [symbol] , |011 [symbol] , . . . , |111 [symbol] . This property sets the foundation of potential quantum increased speed over classical computation. In other words, an exponential number of correlated logical states can be stored and processed simultaneously by the quantum system 300 with a linear number of qubits 334.

A quantum algorithm may be described in terms of a quantum circuit. During quantum compilation, the quantum application 312 may be first decomposed into a set of 1- and 2-qubit discrete quantum operations called logical quantum gates. These quantum gates are represented in matrix form as unitary matrices. 1-qubit gate correspond to rotations along a particular axis on the Bloch sphere. In an exemplary quantum instruction set architecture (“ISA”), the 1-qubit gate set may include rotations along the x-, y-, and z-axes of the Block sphere. Such gates are notated herein as Rₓ, R_{y}, and R_{z} gates, respectively. Further, the quantum ISA may also include a Hadamard gate, which corresponds to a rotation about the diagonal x+z axis. An example of a 2-qubit logical gate in the quantum ISA is a Controlled-NOT (“CNOT” or “CX”) gate, which flips the state of the target qubit if the control qubit is |1 [symbol] or leaves the state unchanged if the control qubit is |0 [symbol] . For example, the CX gate sends |10 [symbol] to |11 [symbol] , sends |11 [symbol] to |10 [symbol] , and preserves the other logical states.

Further, it should be understood that the general logical assembly instructions typically used during compilation of the variational quantum application 312 were designed without direct consideration for the variations in the types of physical hardware (or kernel) that may be used. As such, there is often a mismatch between the logical instructions and the capabilities of the particular quantum information processing (QIP) platform. For example, on some QIP platforms, it may not be obvious how to implement the CX gate directly on that particular physical platform. As such, a CX gate may be further decomposed into physical gates in a standard gate-based compilation. Other example physical quantum gates for various architectures include, for example, in platforms with Heisenberg interaction Hamiltonian, such as quantum dots, the directly implementable 2-qubit physical gate is the \sqrt{SWAP} gate, which implements a SWAP when applied twice. In platforms with ZZ interaction Hamiltonian, such as superconducting systems of Josephson flux qubits and NMR quantum systems, the physical gate is the CPhase gate, which is identical to the CX gate up to single qubit rotations. In platforms with XY interaction Hamiltonian, such as capacitively coupled Josephson charge qubits (e.g., transmon qubits), the 2-qubit physical gate is iSWAP gate. For trapped ion platforms with dipole-chain interaction, two popular physical 2-qubit gates are the geometric phase gate and the XX gate.

The quantum processor 332 may be continuously driven by external physical operations to any state in the space spanned by the logical states. The physical operations, called control fields, are specific to the underlying system, with control fields and system characteristics controlling a unique and time-dependent quantity called the Hamiltonian. The Hamiltonian determines the evolution path of the quantum states. For example, in superconducting systems such as the example quantum computing device 330, the qubits 334 can be driven to rotate continuously on the Bloch sphere by applying microwave electrical signals. By varying the intensity of the microwave signal, the speed of rotation of the qubit 334 can be manipulated. The ability to engineer the system Hamiltonian in real-time allows the quantum system 300 to direct the qubits 334 to the quantum state of interest through precise control of related control fields. Thus, quantum computing may be achieved by constructing a quantum system in which the Hamiltonian evolves in a way that aligns with a high probability upon final measurement of the qubits 334. In the context of quantum control, quantum gates may be regarded as a set of pre-programmed control fields performed on the quantum processor 332.

During operation, the control computing device 310 implements a quantum algorithm, attempting to create as efficient a quantum circuit as possible, where efficiency may be in terms of circuit width (e.g., number of qubits) and depth (e.g., length of critical path, or runtime of the circuit). In some embodiments, the compilation engine 314 optimizes various circuits or subcircuits using IBM Qiskit transpiler, which applies a variety of circuit identities (e.g., aggressive cancellation of CX gates and Hadamard gates). In some embodiments, the compilation engine 314 also performs additional merging of rotation gates (e.g., Rₓ(α) followed by Rₓ(β) merges into Rₓ(α+β)) to further reduce circuit sizes.

At the lowest level of hardware, quantum computers may be controlled by analog pulses. Therefore, quantum compilation translates from a high-level quantum algorithm down to a sequence of control pulses 320. Once a quantum algorithm has been decomposed into a quantum circuit comprising single-and two-qubit gates, gate-based compilation may be performed by concatenating a sequence of pulses corresponding to each gate. In particular, a lookup table maps from each gate in the gate set to a sequence of control pulses that executes that gate. Pure gate-based compilation provides an advantage in short pulse compilation time, as the lookup and concatenation of pulses may be accomplished very quickly.

Some known methods of compilation for variational algorithms use the gate-based approach to compilation, using parameterized gates such as Rₓ(θ) and R_{z}(ϕ). However, the pure gate-based compilation approach may prevent the optimization of pulses from happening across the gates because there might exist a global pulse for an entire circuit that is shorter and more accurate than the concatenated one. The quality of the concatenated pulse may rely heavily on an efficient gate decomposition of the quantum algorithm.

GRAPE is a strategy for compilation that numerically finds the best control pulses needed to execute a quantum circuit or sub-circuit by following a gradient descent procedure. In contrast to the gate-based approach, GRAPE may not have the limitation incurred by the gate decomposition. Instead, the GRAPE-based approach directly searches for the optimal control pulse for the input circuit as a whole. Some embodiments described herein utilize GRAPE for portions of compilation, as described in further detail below.

In the example embodiment, the control computing device 310 includes a compilation engine 314 that, during operation, is configured to compile the variational quantum application 312 (e.g., from source code) into an optimized physical schedule 316. The quantum computing device 330 is a superconducting device and the signal generator 318 is an arbitrary wave generator (“AWG”) configured to perform the optimized control pulses 320 on the quantum processor 332 (e.g., via microwave pulses sent to the qubits 334, where the axis of rotation is determined by the quadrature amplitude modulation of the signal and where the angle of rotation is determined by the pulse length of the signal). The optimized physical schedule 316 may represent a set of control instructions and an associated schedule that, when sent to the quantum computing device 330 as optimized control pulses 320 (e.g., the pre-programmed control fields) by a signal generator 318, causes the quantum computing device 330 to execute the quantum program 312.

In the exemplary embodiment, the optimized physical schedule 316 may represent a set of control instruction and an associated schedule corresponding to each quantum computing device 330 of the ensemble of quantum computing device to perform a respective quantum application operation of the quantum application operations.

An output from the ensemble of quantum devices may be measured and/or a machine learning program 340 may use the outputs for training purposes. In one embodiment a quantum kernel alignment metric may be generated by a quantum kernel alignment metric generation model, which is a non-limiting example of a machine learning program 340 that may be used herein. Even though the machine learning program 340 is shown separate from the ensemble of quantum computing devices 330, the machine learning program 340 may be implemented on the ensemble of quantum computing devices 330. In general, Box 340 is the step where one optimizes the variational parameters in the quantum circuit using classical (computing) optimization methods. In machine learning applications, this step is “classical machine learning based on quantum enhanced data”. It should be understood that other quantum computing architectures may have different supporting hardware.

In some example embodiments, the variational quantum program 312 may be a Variational Quantum Eigensolver (VQE). In these examples, the quantum system 300 may use VQE to find the ground state energy of a molecule. This task is exponentially difficult in general for a classical computer, but efficiently solvable by a quantum computer. Estimating the molecular ground state has important applications to chemistry such as determining reaction rates and molecular geometry. A conventional quantum algorithm for solving this problem is the Quantum Phase Estimation (QPE) algorithm. However, for target precision ε, QPE yields a quantum circuit with depth O(1/ε), whereas VQE algorithm yields O(1/ε²) iterations of depth O(1) circuits. The latter assumes a more relaxed fidelity requirement on the qubits and gate operations, because the higher the circuit depth, the more likely the circuit experiences an error at the end, and possibly a wrong output string may be generated from execution of the quantum application program.

Even if quantum computing devices are manufactured in a highly controlled setting, unavoidable variation may result in each quantum computing device to have different intrinsic properties. Due to each quantum computing device having different intrinsic properties, each quantum computing device's performance may be impacted differently even if each quantum computing device is subjected to the same input conditions in a controlled environment. This variation (in intrinsic properties) between and within quantum computing devices may become apparent while examining error rates.

As will be appreciated based upon the foregoing specification, the above-described embodiments of the disclosure may be implemented using computer programming or engineering techniques including computer software, firmware, hardware or any combination or subset thereof, wherein the technical effect is to compile and optimize a variational quantum program for execution on a quantum processor. Any such resulting program, having computer-readable code means, may be embodied, or provided within one or more computer-readable media, thereby making a computer program product, (e.g., an article of manufacture), according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These conventional computer programs (also known as programs, software, software applications, “apps,” or code) include machine instructions for a conventional programmable processor and may be implemented in a high-level procedural and/or object-oriented programming language, and/or in assembly/machine language. As used herein, the terms “machine-readable medium” and “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

### Exemplary Application Server or a Classical Computing Device

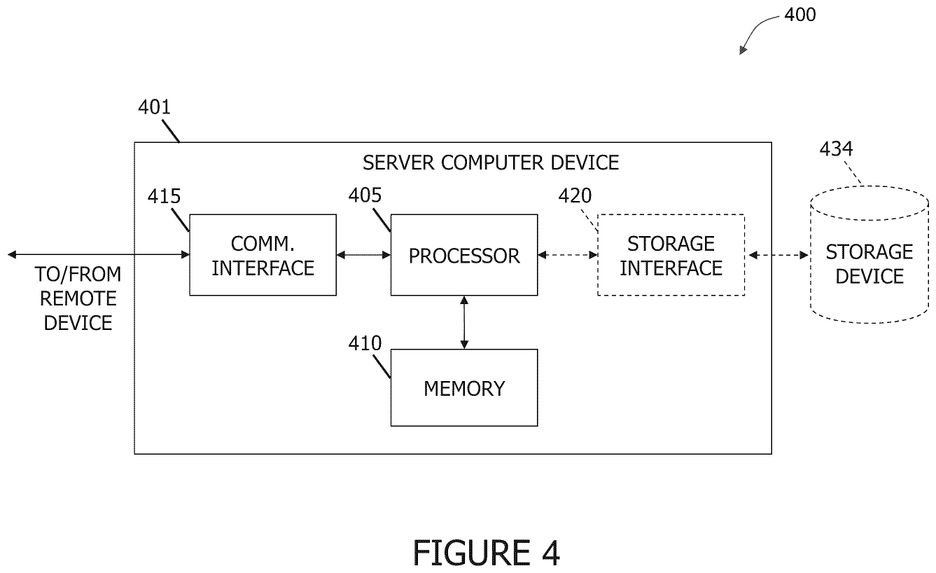

FIG. 4 depicts an exemplary configuration of an application server (or a classical computing device) 400, in accordance with one embodiment of the present disclosure. Application server 400 may be similar to the control computing device 310 (shown in FIG. 3), and may be configured to perform various operations, as described herein, that may be performed using classical computing device or the control computing device 310. Processor 402 may include one or more processing units (e.g., in a multi-core configuration).

Processor 402 may be operatively coupled to a communication interface 406 such that the application server 400 is capable of communicating with a remote device, such as one or more quantum computing devices 430 via communication interface 406. For example, communication interface 406 may receive data, e.g., control pulses, image, video, text, and so on. By way of a non-limiting example, the application server 400 may be a server which may receive a classical data input and may generate a quantum feature map corresponding to the classical data input, and cause execution of the quantum feature map on the one or more control computing devices 310.

Processor 402 may also be operatively coupled to a storage device 408. Storage device 408 may be any computer-operated hardware suitable for storing and/or retrieving data, such as, but not limited to, data associated with historic databases. In some embodiments, storage device 408 may be integrated in the application server 400. For example, the application server 400 may include one or more hard disk drives as storage device 408.

In other embodiments, storage device 408 may be external to classical computing device 400 and may be accessed by a plurality of classical computing devices 400. For example, storage device 408 may include a storage area network (SAN), a network attached storage (NAS) system, and/or multiple storage units such as hard disks and/or solid-state disks in a redundant array of inexpensive disks (RAID) configuration.

In some embodiments, processor 402 may be operatively coupled to storage device 408 via a storage interface 410. Storage interface 410 may be any component capable of providing processor 402 with access to storage device 408. Storage interface 410 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 402 with access to storage device 408.

Processor 402 may execute computer-executable instructions for implementing aspects of the disclosure. In some embodiments, the processor 402 may be transformed into a special purpose microprocessor by executing computer-executable instructions or by otherwise being programmed. In some embodiments, and by way of a non-limiting example, the memory 404 may include instructions to perform specific operations, as described herein.

### Process Flow Performed by Quantum Computing Device

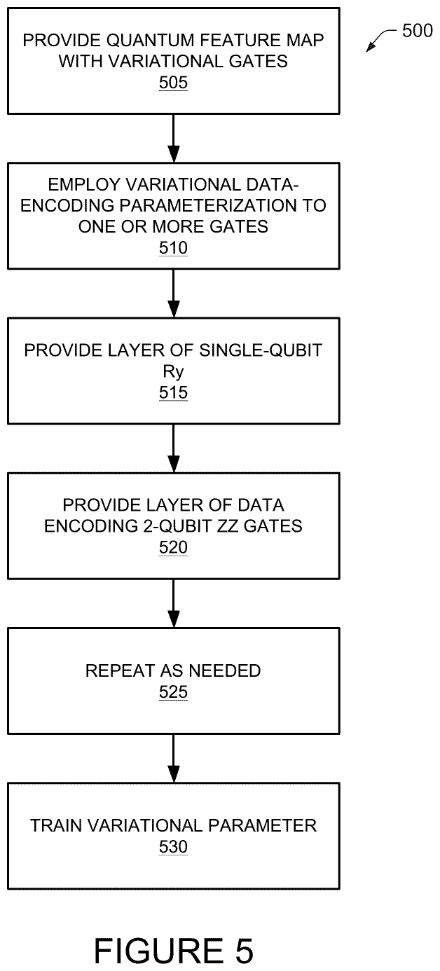

FIG. 5 depicts a process flow diagram for an exemplary computer-implemented method 500 performed by a quantum computing device 330 (shown in FIG. 3). A quantum feature map may be generated at Block 502. An exemplary quantum feature map is shown in FIG. 2. The quantum feature map may correspond to a quantum circuit received by the control computing device from a user. The quantum feature map corresponds with classical-to-quantum mechanical representation. In other words, for each classical data input, a corresponding quantum mechanical representation of a quantum circuit may be generated.

At Blocks 504 and 506, the computer-implemented method 500 may include using variational data-encoding parametrization on one or more layers of single-qubit R_{y} rotations of the map and or one or more layers of conventional data-encoding two-qubit ZZ gates (non-variational). In general, all gates in the circuit may be variational data-encoding gates.

The computer-implemented method 500 may further include providing (Block 508) a layer of conventional data-encoding two-qubit ZZ gates. The ZZ gates may be non-variational.

A kernel matrix may be computed (Block 510) using quantum states produced by each of the quantum feature maps above.

For a given value of θ, a support vector machine algorithm may then be used to perform a prediction based on data, and the quality of the predictions (typically formulated as a cost function), as a function of the value θ, can then be used to guide the optimization of the choice of θ (i.e., variational training). The SVM is used to compute predictions based on θ. θ is trained variationally to improve the quality of the predictions. In the exemplary embodiment, the cost function is a downstream comparison to the truth to make sure that the model making the prediction may be the ideal model.

### Exemplary Embodiments & Functionality

In one embodiment, a computer system for of performing quantum computation may be provided. The computer system may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. For instance, the computer system may include at least one processor in communication with at least one memory device. The at least one processor may be configured to: (1) generate a quantum feature map corresponding to a quantum circuit, wherein the quantum feature map includes a plurality of gates; (2) employ variational data-encoding parameterization to the quantum feature map to convert at least one gate of the plurality of gates into a variational data-encoded gate; and/or (3) execute machine learning processes using the quantum feature map to determine a value for a variational data-encoded parameter associated with the at least one variational data-encoded gate. The computer system may have additional, less, or alternate functionality, including that discussed elsewhere herein.

In some further enhancements, the quantum feature map corresponding to the quantum circuit may include variational gates. The layer of data-encoding qubit gates may promote the variational gates to variational data-encoding gates.

In some further enhancements, the variational data-encoding qubit gates may be configured to encode data.

In some further enhancements, the variational data-encoding parameterization may be employed on a first layer of the quantum feature map.

In some further enhancements, the at least one processor may be further configured to determine a plurality of quantum states using the quantum feature map. The at least one processor may also be configured to compute a kernel matrix using the plurality of quantum states.

In some further enhancements, the layer of data-encoding qubit gates may be non-variational.

In some further enhancements, the layer of data-encoding qubit gates may be two qubit ZZ gates.

In some further enhancements, the quantum feature map initially may be configured with variational gates having single variational parameters.

In some further enhancements, the quantum feature map corresponding to the quantum circuit includes a plurality of variational gates and a plurality of data-encoded gates in addition to the at least one variational data-encoded gate.

In some further enhancements, the quantum feature map represents a plurality of models and wherein the value for the variational data-encoded parameter corresponds to at least one model of the plurality of models.

In some further enhancements, the quantum feature map includes a first layer of qubit gates and a second layer of qubit gates, wherein the first layer of qubit gates includes single-qubit R_{y} rotation gates, and wherein the second layer of qubit gates includes two qubit ZZ gates. Additionally, wherein the first layer of qubit gates are variational gates and wherein the second layer of qubit gates are data-encoding qubit gates.

In some aspects, the present embodiments may relate to a computer-implemented method for of performing quantum computation. The method may include, such as via one or more local or remote processors, transceivers, and memory units, configured for wireless communication and/or data transmission over one or more radio frequency links: (1) generating a quantum feature map corresponding to a quantum circuit, wherein the quantum feature map includes a plurality of gates; (2) employing variational data-encoding parameterization to the quantum feature map to convert at least one gate of the plurality of gates into a variational data-encoded gate; and/or (3) executing machine learning processes using the quantum feature map to determine a value for a variational data-encoded parameter associated with the at least one variational data-encoded gate. The method may include additional, less, or alternate actions, including those discussed elsewhere herein.

In some further enhancements, employing the variational data-encoding parameterization may further include employing the variational data-encoding parameterization on a first layer of the quantum feature map.

In some further enhancements, the method may further include determining a plurality of quantum states using the quantum feature map.

In some further enhancements, the method may further include computing a kernel matrix using the quantum feature map.

In some further enhancements, the layer of data-encoding qubit gates may be non-variational.

In some further enhancements, the method may further include where the layer of data-encoding qubit gates includes two qubit ZZ gates.

In some further enhancements, the method may further include initially configuring the quantum feature map with variational gates having single variational parameters.

In some further enhancements, the quantum feature map corresponding to the quantum circuit includes a plurality of variational gates and a plurality of data-encoded gates in addition to the at least one variational data-encoded gate.

In some further enhancements, the quantum feature map represents a plurality of models and wherein the value for the variational data-encoded parameter corresponds to at least one model of the plurality of models.

In some further enhancements, the quantum feature map includes a first layer of qubit gates and a second layer of qubit gates, wherein the first layer of qubit gates includes single-qubit R_{y} rotation gates, and wherein the second layer of qubit gates includes two qubit ZZ gates. Additionally, wherein the first layer of qubit gates are variational gates and wherein the second layer of qubit gates are data-encoding qubit gates.

In another aspect, at least one non-transitory computer-readable media having computer-executable instructions embodied thereon may be provided. When executed by a computing device including at least one processor in communication with at least one memory device, the computer-executable instructions may cause the at least one processor to: (1) generate a quantum feature map corresponding to a quantum circuit, wherein the quantum feature map includes a plurality of gates; (2) employ variational data-encoding parameterization to the quantum feature map to convert at least one gate of the plurality of gates into a variational data-encoded gate; and/or (3) execute machine learning processes using the quantum feature map to determine a value for a variational data-encoded parameter associated with the at least one variational data-encoded gate. The computer-executable instructions may direct additional, less, or alternate functionality, including that discussed elsewhere herein.

In some further enhancements, the variational data-encoding parameterization may be employed on a first layer of the quantum feature map.

In some further enhancements, the at least one processor may be further configured to determine a plurality of quantum states using the quantum feature map.

In some further enhancements, the at least one processor may be further configured to compute a kernel matrix using the plurality of quantum states.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied, or provided within one or more computer-readable media, thereby making a computer program product, e.g., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In another embodiment, a computer program is provided, and the program is embodied on a computer-readable medium. In one exemplary embodiment, the system is executed on a single computer system, without requiring a connection to a server computer. In a further exemplary embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process may be practiced independent and separate from other components and processes described herein. Each component and process may also be used in combination with other assembly packages and processes. The present embodiments may enhance the functionality and functioning of computers and/or computer systems.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computing device comprising:
at least one memory; and
at least one processor in communication with the at least one memory, wherein the at least one processor is programmed to:
generate a quantum feature map corresponding to a quantum circuit, wherein the quantum feature map includes a plurality of gates;
employ variational data-encoding parameterization to the quantum feature map to convert at least one gate of the plurality of gates into a variational data-encoded gate; and
execute machine learning processes using the quantum feature map to determine a value for a variational data-encoded parameter associated with the at least one variational data-encoded gate.

2. The computing device of claim 1, wherein the quantum feature map corresponding to the quantum circuit includes a plurality of variational gates and a plurality of data-encoded gates in addition to the at least one variational data-encoded gate.

3. The computing device of claim 1, wherein the quantum feature map represents a plurality of models and wherein the value for the variational data-encoded parameter corresponds to at least one model of the plurality of models.

4. The computing device of claim 1, wherein the variational data-encoding parameterization is employed on a first layer of the quantum feature map.

5. The computing device of claim 1, wherein the at least one processor is further programmed to determine a plurality of quantum states using the quantum feature map.

6. The computing device of claim 5, wherein the at least one processor is further programmed to compute a kernel matrix using the plurality of quantum states.

7. The computing device of claim 1, wherein the quantum feature map includes a first layer of qubit gates and a second layer of qubit gates, wherein the first layer of qubit gates includes single-qubit R_{y} rotation gates, and wherein the second layer of qubit gates includes two qubit ZZ gates.

8. The computing device of claim 7, wherein the first layer of qubit gates are variational gates and wherein the second layer of qubit gates are data-encoding qubit gates.

9. The computing device of claim 1, wherein the quantum feature map initially is configured with variational gates having single variational parameters.

10. A computer-implemented method of performing quantum computation using a computing device having at least one processor, the method comprising:
generating a quantum feature map corresponding to a quantum circuit, wherein the quantum feature map includes a plurality of gates;
employing variational data-encoding parameterization to the quantum feature map to convert at least one gate of the plurality of gates into a variational data-encoded gate; and
executing machine learning processes using the quantum feature map to determine a value for a variational data-encoded parameter associated with the at least one variational data-encoded gate.

11. The computer-implemented method of claim 10, wherein the quantum feature map corresponding to the quantum circuit includes a plurality of variational gates and a plurality of data-encoded gates in addition to the at least one variational data-encoded gate.

12. The computer-implemented method of claim 10, wherein the quantum feature map represents a plurality of models and wherein the value for the variational data-encoded parameter corresponds to at least one model of the plurality of models.

13. The computer-implemented method of claim 10 further comprising determining a plurality of quantum states using the quantum feature map.

14. The computer-implemented method of claim 13 further comprising computing a kernel matrix using the quantum feature map.

15. The computer-implemented method of claim 10, wherein the quantum feature map includes a first layer of qubit gates and a second layer of qubit gates, wherein the first layer of qubit gates includes single-qubit R_{y} rotation gates, and wherein the second layer of qubit gates includes two qubit ZZ gates.

16. The computer-implemented method of claim 15, wherein the first layer of qubit gates are variational gates and wherein the second layer of qubit gates are data-encoding qubit gates.

17. The computer-implemented method of claim 10 further comprising initially configuring the quantum feature map with variational gates having single variational parameters.

18. At least one non-transitory computer-readable storage medium with instructions stored thereon that, in response to execution by at least one processor, cause the at least one processor to:
generate a quantum feature map corresponding to a quantum circuit, wherein the quantum feature map includes a plurality of gates;
employ variational data-encoding parameterization to the quantum feature map to convert at least one gate of the plurality of gates into a variational data-encoded gate; and
execute machine learning processes using the quantum feature map to determine a value for a variational data-encoded parameter associated with the at least one variational data-encoded gate.

19. The at least one non-transitory computer-readable storage medium of claim 18, wherein the variational data-encoding parameterization is employed on a first layer of the quantum feature map.

20. The at least one non-transitory computer-readable storage medium of claim 18, wherein the at least one processor is further configured to determine a plurality of quantum states using the quantum feature map.
